(19) United States
(12) Patent Application Publication
(10) Pub. No.: US 2012/0159844 A1
(43) Pub. Date: Jun. 28, 2012

(54) Adjustable stake assembly and method of use

(76) Inventor: Kenneth W. Davis, Bernardsville, NJ (US)

(21) Appl. No.: 13/385,204

(22) Filed: Feb. 7, 2012

Related U.S. Application Data
(63) Continuation-in-part of application No. 12/800,501, filed on May 17, 2010.

(51) Int. Cl. A01G 17/06; A01G 1/00; A01G 17/14

(52) U.S. Cl. 47/45; 47/47; 47/58.1 R

(57) ABSTRACT

An adjustable stake assembly forms a plant support, lattice, fence, plant holder, recreational or decorative structure. The stake assembly includes a universal stake support having a pointed angular tip that penetrates a surface, a body portion with a protrusion having a stake aperture, and a horizontal member extending perpendicularly from said body portion and said tip. At least one stake segment has a central portion. A lateral and distal end is appointed to be removably snapped-onto the universal stake support. A segment aperture is appointed to receive another stake segment for vertically stacking a plurality of the stake segments. In another embodiment, the stake segments include at least one lateral connector section. The stake segments can be interconnected to one another for horizontal cross-connection when forming plant supports, lattices, fences, or other structures.

This is a Continuation-In-Part of application Ser. No. 12/800,501, filed May 17, 2010 for “Adjustable Stake Assembly And Method Of Use”, the disclosure of which is hereby incorporated in its entirety by reference thereto.

### BACKGROUND OF THE INVENTION

1. Field Of The Invention

The present invention relates to an adjustable stake assembly and method of use; and more particularly, to an adjustable stake assembly that can be readily snapped together on the vertical and horizontal planes to offer both height and horizontal cross-wise adjustment when forming lattice, fences, barriers, or a plethora of structures.

2. Description of the Prior Art

Sprawling plants growing upwardly oftentimes require a vertical support. Examples of sprawling plants where vertical supports are commonly implemented include tomatoes, peas, cucumbers, flowers, etc., and vine type plants. Currently stakes are offered as one size. However, where the plant height extends the stake height, the stake must be replaced with a bigger stake. Storage of large or tall stakes can become cumbersome. Moreover, various fencing and plant coverings are required to protect plants while they are growing in order to facilitate proper growth.

Several approaches devised by prior art workers attempt to provide solutions for providing vertical support for climbing plants. These approaches include 1) use of stakes; 2) use of stakes which include expansion and bisecting rods; or 3) expansion stakes that accommodate height growth. None of these solutions suggests an adjustable stake assembly that can readily be snapped together on the vertical and horizontal planes to not only offer height adjustment, but to also offer horizontal adjustment, as well as the ability to form fences and other barriers or structures to protect plants during growth.

U.S. Pat. No. 4,610,107 to Testa discloses an improved vine trainer, which is assembled and disassembled to become portable in kit form. A central stake is provided that is comprised of a plurality of interconnected sections. A number of rods, shorter in length than the central stake, are stacked and crossed with each rod bisecting the others and are removably affixed to the upper portion of the central stake. The rods are formed with openings on each end for receiving twine, wire, or the like, and secured to ground stakes which are inserted into the earth or potting soil of a potted plant, providing a substantially vertical and rigid surface on which plant vines can grow.

U.S. Pat. No. 5,640,802 to Elliott discloses a support assembly for growing tomato plants during the various stages of growth by utilizing interchangeable parts including post sections having a tapered member (A) on a bottom end and a tapered socket (B) on the other end for joining the sections to form continuous posts having vertically spaced seating locations (C), and horizontal supports (D) having sockets (E) which fit securely onto post sections and are spaced vertically to form modules that may be stacked in vertical relation and thereby added progressively to meet the needs engendered by growth of the plant and to permit ready access to the plant.

U.S. Pat. No. 6,922,942 to Stefanutti discloses a vine wire support post molded as integral unit from plastics with an elongate tapered supporting portion having upper end and lower end, a wire attachment provided on the supporting portion, a peg for holding support post in ground joined to lower end of supporting portion, a foot at the join between peg and supporting portion. The supporting portion is flexible and has variable sectional strength decreasing over a length of supporting portion from a position of higher sectional strength nearer the lower end to a position of lower sectional strength nearer the upper end.

U.S. Pat. No. 7,004,403 to Thayer et al. discloses an irrigation spray stake for plants grown in pots utilizing an elongated stake member having an upper extremity and a lower extremity adapted to be inserted into the soil, with a spray head adjacent the upper extremity of the stake member, with an arrow or similar feature along the stake member between the upper and lower extremities to indicate the predetermined spraying direction of the spray head. The arrow or similar feature may be formed as a plate which rests against the surface of the soil, with the back edge of the plate resting against the inner surface of the nursery pot into which the stake is extended.

U.S. Patent App. Pub. No. 2008/0190019 to Hart discloses a plant support system having a central post, at least first and second cross pieces, and a plurality of strings. The central post has a first end disposed in the ground and an opposite second end. The cross pieces extend outwardly from the central post second end. Each of the cross pieces has a first end releaseably securable to the central post second end and a second distal end. Each of the strings is securable to a corresponding one of the cross pieces. A plant growing proximate the central post is attachable to a corresponding one of the strings as the plant grows upwardly. The present invention also relates to a method of supporting growing plants.

U.S. Patent App. Pub. No. 2008/0209802 to Williams discloses a gardening stake kit for plant training including a plurality of shaft segments that are connectable end to end to form a shaft of variable lengths. A plurality of grooves or protrusions is formed in or on an outer periphery of each shaft segment. A pointed base is connectable to one end of a shaft segment, and a plurality of arms that are connectable to the grooves or protrusions formed in each shaft segment. Preferably, the grooves or protrusions are formed at more than one angle relative to the top and bottom of each shaft segment and, preferably, include horizontal grooves or protrusions as well as angular grooves. No disclosure is contained in Williams concerning use of support holes. Moreover, in the gardening stake kit of Williams, each of a central portion and a lateral end portion do not include at least one support hole. Furthermore, Williams does not disclose or suggest insertion of a string or rope within one or more support holes to tie up plants or vines to secure them against the adjustment as a plant grows.

U.S. Patent App. Pub. No. 2009/0077879 to Lisciotti et al. discloses a telescoping pole for supporting growing plants, which comprises two or more elongate pole members, one of which has a pointed stake section at one end to facilitate insertion into the ground. The pole includes means for locking the elongate pole members in a number of different telescoped positions, whereby to allow for adjustment of the effective length of the pole according to the height of the plant that it supports. The telescoping members are made of a polymer material, with at least one of the telescoping members comprising two injection-molded component parts that are mechanically attached to one another.

U.S. Patent App. Pub. No. 2010/0005714 to Aiken discloses an apparatus for supporting plants growing from the ground includes an elongated rigid pole with a plurality of axially-spaced apertures along much of the pole. Flexible cord ties are threaded in a spiral fashion through at least three apertures in the long wall of the elongated pole, and knots at the ends are tied around plant stems or branches thereby preventing disengagement from the holes and simultaneously supporting the plant. One end of the elongated pole is cut at an angle to the axis to form a point.

Foreign Pub. No. DE 3,312,130 to Mez discloses a plant stake of the helically coiled type made of iron is to be capable of easily being stably anchored in the earth. To this end, according to FIG. 2, a ground anchor is provided, which has the form of an arrowhead with radially projecting ribs. The shaft of the plant stake is inserted into an axial bore. The ground anchor can, with small penetration depth into the earth, adequately support the plant stake. Use in private and industrial horticulture as well as in pot plants.

Foreign Pub. No. FR 2,758,044 to Benfeghoul discloses a plant stake formed as a post, which is hollow, with an open end at its upper part and closed at its lower extremity, which is designed to be inserted into the ground. The post is fitted with a pipe, which is fitted towards the bottom of the post and is designed to lead the liquid to the base of the plant to be irrigated. The pipe is fitted with a flow control device, which allows the liquid, held in the post to be drip fed to irrigate the plant. The flow can be uniformly regulated or can be fed by a manually adjusted device. The post is designed to support plants or support wires in the normal way, by means of a series of holes (4) in the side flange of the post.

Foreign Pub. No. FR 2,914,339 to Hildbrand discloses a multiuse stud for supporting branches of fruit tree, has parallelepiped section tubes stacked with each other until attaining required height, and spring serving as resilient suspension to upper element of stud. The stud has rectangular or parallelepiped section tubes (1) stacked with each other until attaining required height, where each tube is maintained at the required height with respect to the other tube by a pin (3). The pin penetrates in an opening corresponding to an opening formed in a receiver tube. A metallic yoke (4) penetrates in an upper tubular of the stud, and a spring (5) serves as resilient suspension to an upper element of the stud. A support of a tree branch comprises a cylindrical metallic element with V shaped lower surface that is covered by rubber or plastic.

Foreign Pub. No. GB 2,309,878 to Bishop discloses a plant support rod that comprises first 114a and second 214a section. Each section has upper and lower opposed end portions, the first section 114a having a terminal part 116 at its lower end and being releasably connectable at its upper end to the second section 214a. Additional sections can be added as the plant grows, of the same or of a different length to that of the first and/or second sections. Also disclosed is an assembly of the first and second sections, the sections lying side by side and held by a transparent plastics envelope.

Foreign Pub. No. GB 2,359,722 to Mclean discloses a device for the support, training and containment of plants, which includes positive attachment points along the length of the device and incorporates a finther attachment eye at the top of the stake.

Various border columns with metal posts have been provided. One such structure can be found at kinsmangarden.com, which discloses a border column kit having a metal post including an eighteen inch ground spike, a three foot black metal tubular column and a nine inch plate with gripping clips for receiving a basket. Another structure can be found at whieflowerfarm.com/tomato.com which discloses a support for tomatoes having a cage those folds for storage, and discloses red plant ladders having seven v-shaped cross-braces and thirteen inch legs for supporting plants. A Stackable Joint 2-Pack is disclosed at farmtek.com that includes a pair of stacking joints and a finishing sleeve for forming a raised bed, sandbox, water garden, landscape borders, ice skating rings and more.

Notwithstanding the efforts of prior art workers to construct adjustable stake assemblies and the like, there remains a need in the art for an adjustable stake assembly that can readily be snapped together on the vertical and horizontal planes to not only offer height adjustment, but to also offer horizontal climbing adjustment. There is a further need in the art for an adjustable stake assembly that also can be snapped together to form fences and other barriers or structures to protect plants during growth. Additionally, there is a need in the art for an adjustable stake assembly having a plethora of separate applications for decoration and recreation to form flower pot holders, hold netting for sporting activities, and/or form poles or flag pole holders. Still further, there exists a need in the art for an adjustable stake assembly that includes a sharp tip and a wedge portion which, when stepped on, provides downward thrust sufficient to secure placement of the stake assembly within the ground without having to hammer the stake into position through use of mallets and the like.

### SUMMARY OF THE INVENTION

The present invention provides an adjustable stake assembly that can readily be snapped together on the vertical and horizontal planes to offer both height and horizontal climbing adjustment when forming lattice and fence type structures. The adjustable stake assembly includes an assembly portion that can includes a relatively sharp pointed tip and a wedge shaped portion perpendicular to the tip which, when stepped on, provides downward thrust sufficient to secure placement of the stake assembly within the ground without having to hammer the stake into position through use of mallets and the like. The adjustable stake assembly can be snapped together to form a plethora of structures such as plant supports, fences and other barriers or structures to protect plants during growth. Advantageously, the adjustable stake assembly has a plethora of separate applications for decoration and recreation to form flower pot holders, hold netting for sporting activities, and/or form poles or flag pole holders.

The adjustable stake assembly has a stake support appointed to receive at least one stake segment to form a structure, such as a plant support, lattice, fence, plant holder, recreational or decorative structure. The adjustable stake assembly includes a universal stake support having a pointed tip appointed to penetrate a surface, a body portion and a wedge shaped member, wherein the body portion includes a protrusion with a stake aperture integrated therein. At least one stake segment having a central portion and a lateral and distal end, the lateral end having a flange appointed to be received in the stake aperture of the universal stake support, and the distal end having a segment aperture integrated therein, and appointed for receiving another stake segment for vertically stacking a plurality of the stake segments. The central portion of the stake segment comprises at least one support hole. Additionally, the lateral end of the stake segment includes at least on support hole. The horizontal member is formed within the stake support located in close proximity to and substantially perpendicular to the tip.

In another embodiment the stake segments include at least one lateral connector section appointed for receiving at least one lateral connector section of another stake segment for cross-connection of the stake segments in relation to one another. Advantageously, in this manner the stake segments can be interconnected to one another for horizontal cross-connection in forming lattices, fences, or other structures.

A method of using the adjustable stake assembly is also provided. The method involves the first step of selecting a universal stake support. The universal stake support includes a pointed tip appointed to penetrate a surface, a body portion and a wedge shaped member, wherein the body portion has a protrusion with a stake aperture integrated therein. The central portion of the stake segment comprises at least one support hole. The lateral end of the stake segment includes at least one support hole. The horizontal member is formed within the stake support located in close proximity to and substantially perpendicular to the tip. The next step involves inserting the universal stake support into the surface by applying a downward force to the horizontal member. This is readily accomplished by stepping on the horizontal member to thereby cause the pointed tip of the stake support to penetrate the surface of the ground. Due to the acute angle formed by the pointed tip at the end of the horizontal member, the stake is readily secured within the ground without need to hammer it in through use of mallets or the like. Once the stake is secured within the ground, there can be attached to the universal stake support at least one stake segment. The stake segment has a central portion and a lateral and distal end. A flange at the lateral end of the stake segment is appointed to be received in a stake aperture of the universal stake support. The distal end of the stake segment has integrated therein a segment aperture appointed to receive another stake segment. In this manner, a plurality of the stake segments can be staked vertically to significantly extend the length of the adjustable stake assembly.

### BRIEF DESCRIPTION OF THE DRAWINGS

The invention will be more fully understood and further advantages will become apparent when reference is had to the following detailed description of the preferred embodiments of the invention and the accompanying drawings, in which:

FIG. 1 is a schematic view of a first embodiment of the adjustable stake assembly shown a partially assembled condition;

FIG. 2a is a side view of an embodiment of a stake support as shown in FIG. 1;

FIG. 2b is a top view of the top of the stake support;

FIG. 2c is a cross-section view taken at line xx-xx;

FIG. 3a is a schematic view of an embodiment of the adjustable stake assembly kit shown disassembled;

FIG. 3b is a schematic view of the embodiment of the adjustable stake assembly kit shown generally assembled and with corner connectors;

FIG. 4a is a schematic view of another embodiment of a stake support;

FIG. 4b is a front view of the stake support;

FIG. 4c is a side view of the stake support;

FIG. 4d is a top view of the stake support;

FIG. 5 is a side view of the stake support, showing the subject adjustable stake assembly supporting a tomato plant;

FIG. 6 is a schematic view of the first embodiment of the adjustable stake assembly erected with a lattice/fencing insert to form a lattice/fence;

FIG. 7a is a schematic view of another embodiment of the adjustable stake assembly wherein the central portion of the stake segment comprises at least one lateral connector section, herein shown as two lateral connector sections, appointed for receiving lateral connector sections of other stake segments for cross-wise connection of the stake segments in relation to one another and in relation to universal stake supports;

FIG. 7b is a view of the embodiment of FIG. 7a being snapped together to form a support;

FIG. 8a is a view of the embodiment of FIG. 7a snapped together to form a fence or lattice structure that may be used for a plethora of operations, including as a plant lattice, fencing around an area, or to create a gate type structure;

FIG. 8b is a view of the embodiment of FIG. 7a snapped together to form a fence or lattice structure in another configuration that may be used for a plethora of operations, including as a plant lattice, fencing around an area, or to create a gate type structure;

FIG. 8c is a view of the embodiment of FIG. 7a snapped together to form a lattice structure in another configuration such as for holding hanging baskets or the like;

FIG. 8d is a view of the embodiment of FIG. 7a showing a single adjustable stake assembly supporting a tomato plant;

FIG. 9 is a view of the adjustable stake assembly being configured to hold a fence attachment for landscaping plants;

FIG. 10 is a view of the adjustable stake assembly being configured to hold a cross-link fence attachment for keeping pests out of a garden;

FIG. 11 is a view of the adjustable stake assembly being configured to hold a plate attachment for forming a plant holder;

FIG. 12 is a view of the adjustable stake assembly being utilized to hold a tarp or plastic in a garden;

FIG. 13 is a view of the adjustable stake assembly being configured to hold a net attachment for forming a recreational net for volleyball or bad mitten, or the like; and

FIG. 14 is a view of the adjustable stake assembly being configured to hold a flag attachment for forming a flag pole or decorative assembly.

### DETAILED DESCRIPTION OF THE INVENTION

The present invention provides an adjustable stake assembly having a stake support appointed to receive at least one stake segment to form a structure, such as a plant support, lattice, fence, plant holder, recreational or decorative structure. The adjustable stake assembly includes a universal stake support having a pointed tip for penetrating a surface, a body portion and a wedge shaped portion having a protrusion with a stake aperture integrated therein. At least one stake segment having a central portion and a lateral and distal end is appointed to be removably snapped-onto the universal stake support. The stake segment includes a flange appointed to be received in the stake aperture of the universal stake support, and the distal end having a segment aperture integrated therein appointed for receiving another stake segment for vertically stacking a plurality of the stake segments. In another embodiment the stake segments include at least one lateral connector section appointed for receiving at least one lateral connector section of another stake segment for cross-connection of the stake segments in relation to one another. Advantageously, in this manner the stake segments can be interconnected to one another for horizontal cross-connection in forming lattices, fences, or other structures.

The pointed sharp tip of the stake support forms an acute angle with the body portion of the stake assembly. This construction facilitates insertion of the stake support into the ground. Significantly, the pointed sharp tip not only cuts through the ground or surface particulate, but deflects around and thereby avoids small rocks and stones that would otherwise cause difficulty during insertion of the stake support. The pointed sharp tip preferably has a length of about 3 inches up to about 12 inches. Preferably, the pointed sharp tip has a length of about 4 inches up to 7 inches. Most preferably, the pointed sharp tip has a length of about five inches. The length of the pointed sharp tip advantageously assures that the angle from the end of the tip to the stake assembly's body portion is sufficiently acute that insertion into the ground or surface is facilitated. At the same time the length of the pointed sharp tip cooperates with the wedge shaped portion to govern the insertion depth of the stake assembly into the ground, thereby optimizing securement of the assembly in a stable condition that prevents it from toppling or falling over. The width of which is sufficient to facilitate pressing the Stake into the ground without need for mallets and the like.

The distance from the point of stake support to the horizontal member ranges from about 4 to 8 inches. More preferably, the distance from the point of stake support to the horizontal member ranges from 4.5 to 6 inches. The 4 to 8 inches distance and, in particular, longer distances approaching 8 inches optimize the insertion force required to force the stake support into the ground. Specifically, the greater the distance of the horizontal member from the point/tip of the stake support, the greater becomes the translation of force as the stake support is being inserted into the ground. This, in turn, reduces the actual force required to effect insertion to a depth required to stabilize the stake assembly. The wedge shape of the horizontal member/elongated horizontal member and the acute angle formed at the point/tip of the stake assembly facilitates pressing the stake into the ground, thereby securely anchoring the stake to the ground without the need to use mallets and the like.

The length of the horizontal member (top view) itself preferably ranges from about 4 to 8 inches. More preferably, the length of the horizontal member (top view) ranges from 4.5 to 12 inches. In this manner, the horizontal member provides a greater surface area for the user's foot to press downwardly, thereby facilitating the application of force required when securing the stake support into the ground. Additionally, the larger length horizontal member increases the available surface area of the member for the user to grasp when removing the stake support from the ground surface.

Vine type plants and upwardly growing plants require vertical support. Such plants include tomatoes, peas, cucumbers, flowers, etc., and vine type plants. Currently stakes are offered as one size. However, where the plant height extends the stake height, the stake must be replaced with a bigger stake. In such cases, storage of large or tall stakes can become cumbersome. Advantageously, the adjustable stake assembly herein provides the ability to simply extend the vertical height and/or horizontal width of the stake by adding segments thereto. As the plant grows the adjustable stake assembly does not need to be replaced by an entirely new stake. Rather, a segment is simply added to the stake to increase its height or horizontal width. The adjustable stake assembly can be taken apart for compact storage and shipping; and further segments can be purchased for addition to an existing starter kit. The adjustable stake assembly may be provided as a kit having a few, typically five or six, universal stake supports and a plurality, typically ten or twenty, stake segments. If the user desires to build a larger structure than the kit can accommodate, the user can simply purchase additional stake segments and/or additional universal stake supports.

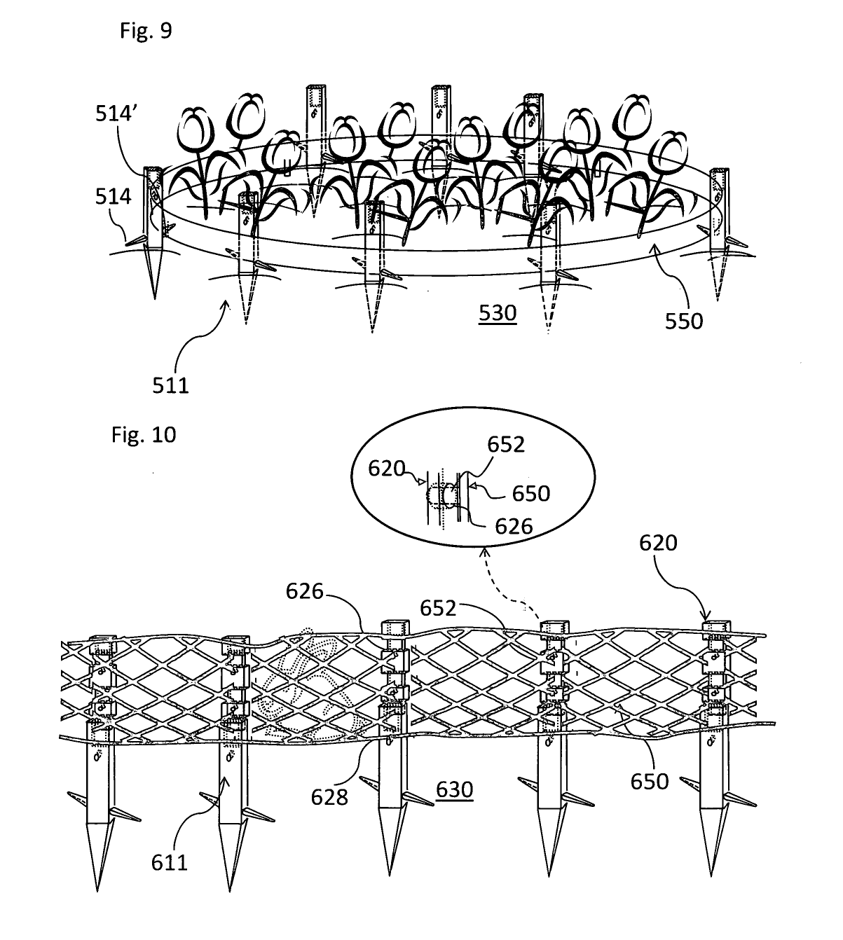

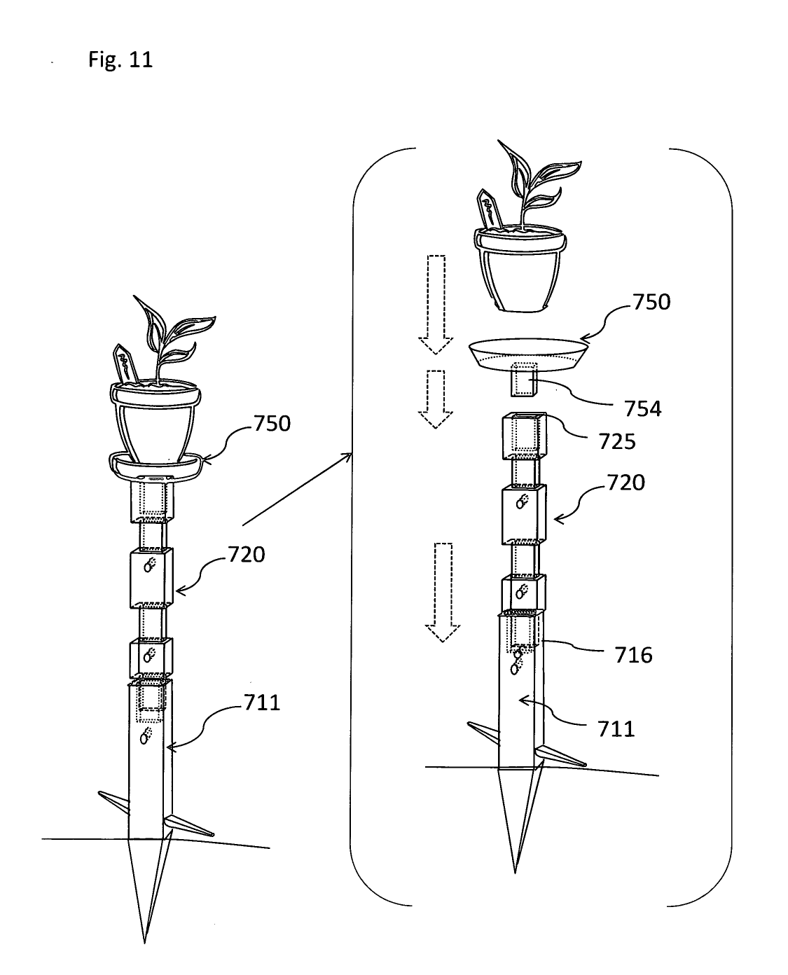

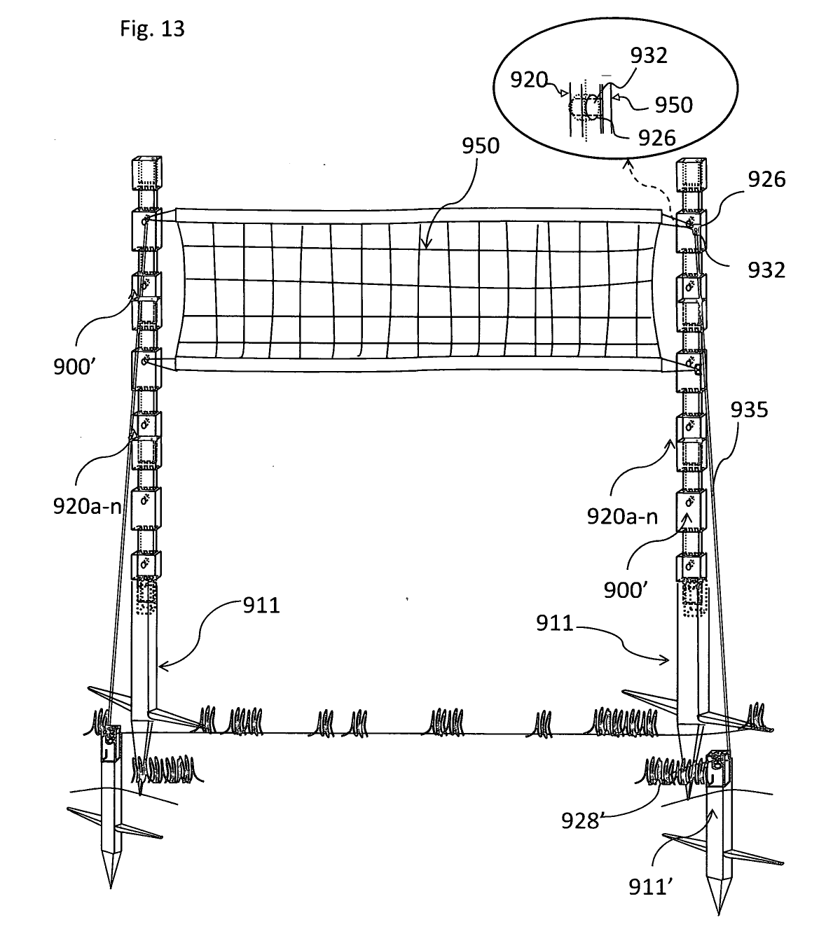

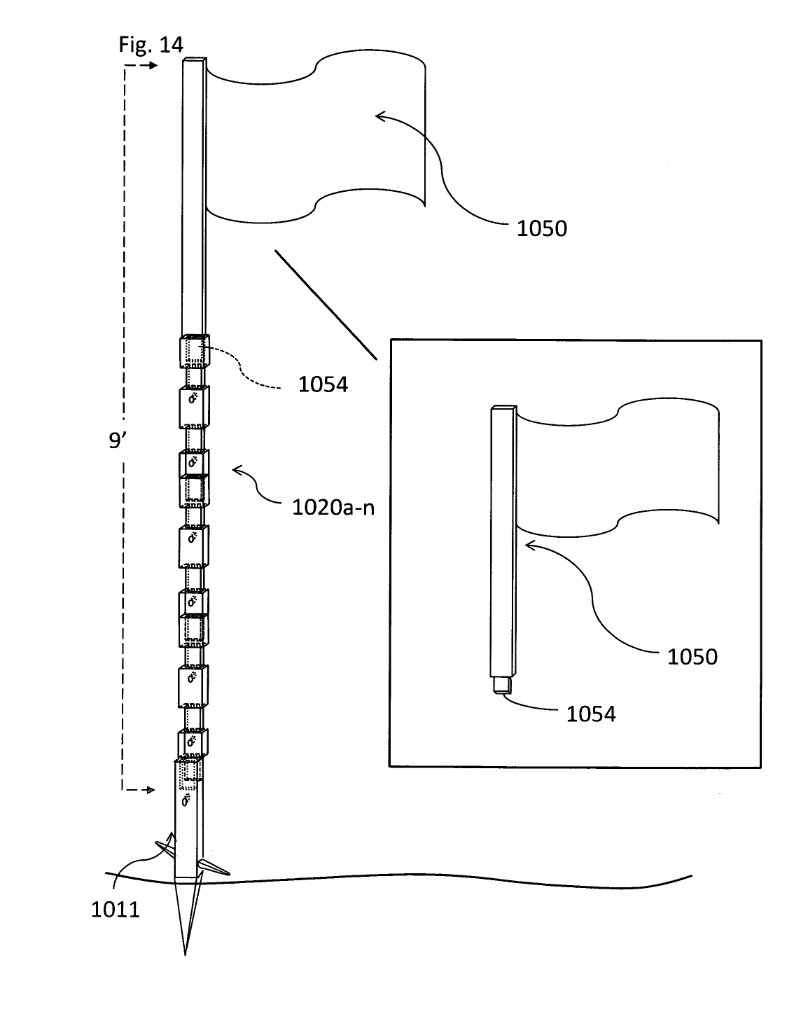

Various add-on devices are provided that can readily snap-fit with the adjustable stake assembly. For example, a plate attachment (i.e. see FIG. 11) is provided that can readily be snapped-onto the assembly to provide a plant holder or small outdoor end table. This affords a user a quick fix to provide a plant holder or small cocktail end table to a patio or lawn area. Other add-ons offered by the assembly herein include recreational netting that can be readily attached to the assembly to form a volleyball or bad mitten game court (i.e. see FIG. 13). The net may be sold as a part of the adjustable assembly kit, or may be a separate net that can simply be attached to the assembly by way of cable tie (zip tie), straps including hook and loop fastener sections (such as that commonly sold under the trade name VELCRO), or rope. Further add-ons include fencing portions, lattices, gardening borders, and flags (i.e. see FIGS. 9-14).

In use the universal stake support is pressed into the ground by stepping on the horizontal member of the support. A plurality of segments which fit into each other are applied to extend the assembly vertically and/or horizontally to extend the stake as plants/tomatoes grow. The use of segments facilitates shipping of the stake components in smaller containers. The stake assembly can be made of injection molded plastic. It can also be made from wood or metal (preferably aluminum).

The adjustable stake assembly can be used as a quick strong support for plants that climb six or seven feet, such as snow peas, cucumbers, tomatoes, etc. In a second embodiment the extension pieces/stake segments are notched in at least one place, preferably at least two places, to form lateral connector sections appointed for receiving corresponding lateral connector sections of other stake segments for cross-wise connection on the horizontal plane. The extension pieces/stake segments are thereby not only used to lengthen the base/universal support stake on the vertical plane, but also are used to expand the assembly for width expansion on the horizontal plane. The segments are used like Lego® type interconnected cross pieces which can be used to form a variety of configurations. In this manner, the adjustable stake assembly becomes a system of interconnected supports and segments that can be used for hanging plants, forming lattice work for climbing plants, to form fence structures or gates. The segment's configuration allows the segments/extension pieces to be extended both vertically and horizontally in a variety of schemes advantageously presenting versatility to the user.

Preferably each of the universal stake supports and the stake segments include at least one support hole. The support hole is a hole that transverses through each of the supports and/or segments and provides the ability for the insertion of a string or rope within the hole for tying up plants or vines so secure same against the adjustment assembly as the plant grows. The support holes may also be used to tie such things as nets, chain link fencing, plastic fencing, mesh fencing, rope fencing or the like, to the erected adjustment assembly. What is more, the universal stake support and stake segments may include at least one fastener means, such as a hook or a latch that is appointed to hold landscape tracts, boarder fencing, ties, ropes, nets, chain link fencing, plastic fencing, mesh fencing, rope fencing or the like, to the erected adjustment assembly.

The universal stake support preferably has a height of twelve (12″) to thirty-two (32″) inches in height. Most preferably the universal stake support is twenty-four (24″) inches in height. The horizontal member of the universal stake support preferably is an elongated substantially flat top wedge/triangular shaped element extending from the sides of the body of the stake support, having a width ranging between 1 to 3 inches and a length ranging between about 4 to 12 inches, and preferably 4.5 to 6 inches (extending per side of the body of the stake support). Preferably the protrusion/aperture located on the top plate is located at a center point on the top plate of the universal stake support so that the protrusion (1.5″) is located four (4″) to fourteen (14″) inches from the top of the horizontal member to provide spacing for a user's foot to fit for pressing the support spike into the ground for a secure fit. Preferably each of the stake segments/extensions has a height ranging in twelve (12″) to twenty (24″) inches—and most preferably have a height of eighteen (18″) inches. This size and height structure of the universal stake and stake segments provide functional advantageous to the assembly. Accordingly, the height of the universal support enables the support to provide optimal structural support for holding up the attached stake segments/extension so that the assembly does not topple over and provides durable, reliable structural support to the assembly and the climbing plant. Moreover, the height range of the universal stake support provides the ability to use the support alone as spikes or the like in forming shallow fences or landscaping boards as well as in use in stabilizing and securing plastic mulch, plastic or tarps in gardens or flower beds. The diameter of the horizontal member and location of the protrusion on the top plate allows the user to utilized the top plate as a foot support allowing maximum downward force for the insertion of the stake into the ground—therefore the distance between the edge of the horizontal member and the point should be at least four (4″) to eleven (11″) inches. The height/length of the stake segments provides the ability to adequately add height to the assembly while not compromising the structural durability and integrity of the assembly's erected structure.

In an embodiment of the stake segments the segment's central portion is constructed having at least one notch/lateral connector section appointed for receiving at least one lateral connector section of another stake segment for cross-wise connection of the stake segments in relation to one another. Preferably, at least two notches/lateral connector sections are provided, each being appointed to receive at least one lateral connector section of two other stake segments for cross-wise lattice connection of the stake segments in relation to one another. The notches/lateral connector sections of the central portion of the stake segment is constructed having a major portion abutting a minor portion, wherein the minor portion has a smaller size than the major portion forming the lateral connector section. Wherein the central portion of the stake segment is constructed having two notches/lateral connector sections there is a major portion abutting two minor portions on either side thereof, wherein the minor portions have a smaller size than the major portion forming at least two the lateral connector sections. In this formation, the stake segments can readily snap onto one another to form a plethora of structures.

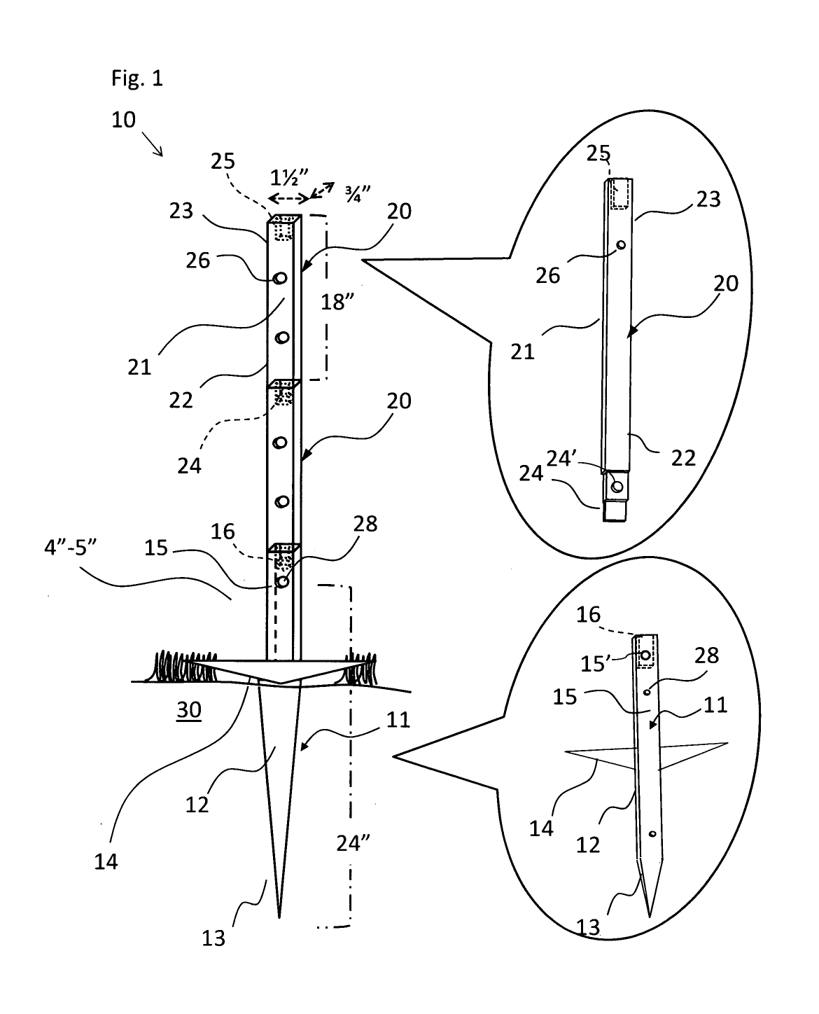

FIG. 1 is a schematic view of a first embodiment of the adjustable stake assembly, shown generally at 10. In the embodiment shown, the adjustable stake assembly is constructed having a universal stake support 11 and at least one stake segment 20, herein shown having two stake segments 20 attached thereto. Universal stake support 11 comprises a first and second end, the first end having an angular-sharp tip 13 appointed to penetrate a surface (herein, ground 30), a body portion 12 and a horizontal member 14. The second end has a protrusion 15 with a stake aperture 16 integrated therein.

At least one stake segment 20 having a central portion 21, a lateral end 22 and distal end 23 is provided. Lateral end 22 includes a flange 24 appointed to be received in the stake aperture 16 of the universal stake support 11. Distal end 23 includes a segment aperture 25 integrated therein appointed for receiving another stake segment 20 for vertically stacking a plurality of the stake segments 20a-n to extend the height of the assembly 10. Preferably the protrusion 15 includes a locking/aligning hole 15′ therein for mating with a locking mechanism (ball or bulbous portion) 24′ located in the flange of the stake segment for releasably securing the flange within the aperture of the stake support.

Stake segment 20 additionally includes a plurality of support holes/apertures 26 to tie tomatoes to the stake segment 20. Universal stake support 11 may also include support hole/aperture 28 for insertion of ties or the like. In use the adjustable stake assembly can be pressed into the ground by stepping on the side projection/top plate 14. Optionally, the adjustable stake assembly can comprise a plurality of segments 20 which fit into each other to extend the stake as tomatoes grow. The use of segments 20 facilitates shipping of the stake components in smaller containers. The stake assembly 10 can be made of injection molded plastic. It can also be made from wood or metal (preferably aluminum).

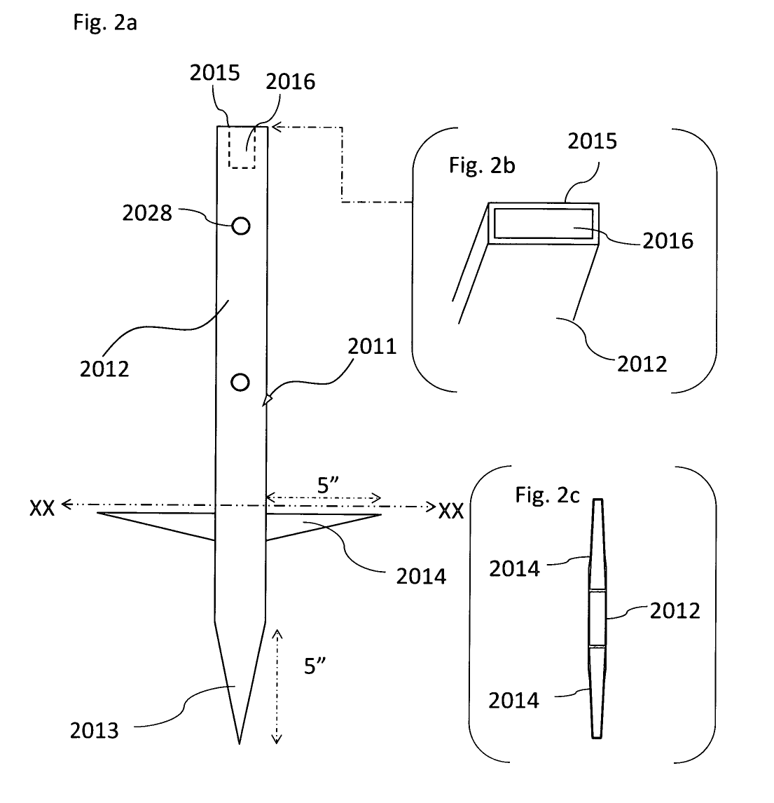

FIG. 2a is a side view of an embodiment of a stake support as shown in FIG. 1. FIG. 2b is a top view of the top of the stake support. FIG. 2c is a cross-section view taken at line xx-xx. Referring to FIGS. 2a-2c, the universal stake support 2011 comprises a first and second end, the first end having an angular-sharp tip 2013 to penetrate a surface. The stake support 2011 has a body portion 2012 and a horizontal member 2014. The second end has a protrusion 2015 with a stake aperture 2016 integrated therein. Horizontal member 2014 is formed within the stake support 2011 and is located in the body portion 2012 near tip 2013. Horizontal member 2014 is substantially perpendicular to said body portion 2012 and tip 2013. Horizontal member 2014 is formed having triangular shape so that the underside of the horizontal member 2014 is angled so that the member 2014 can rest flush against the ground, while the top of the horizontal member 2014 is substantially flat so that a user's foot can rest on the top of the horizontal member 2014. Support holes/apertures 2028 are preferably provided for insertion of ties or the like and are preferably spaced about 6 inches apart from one another.

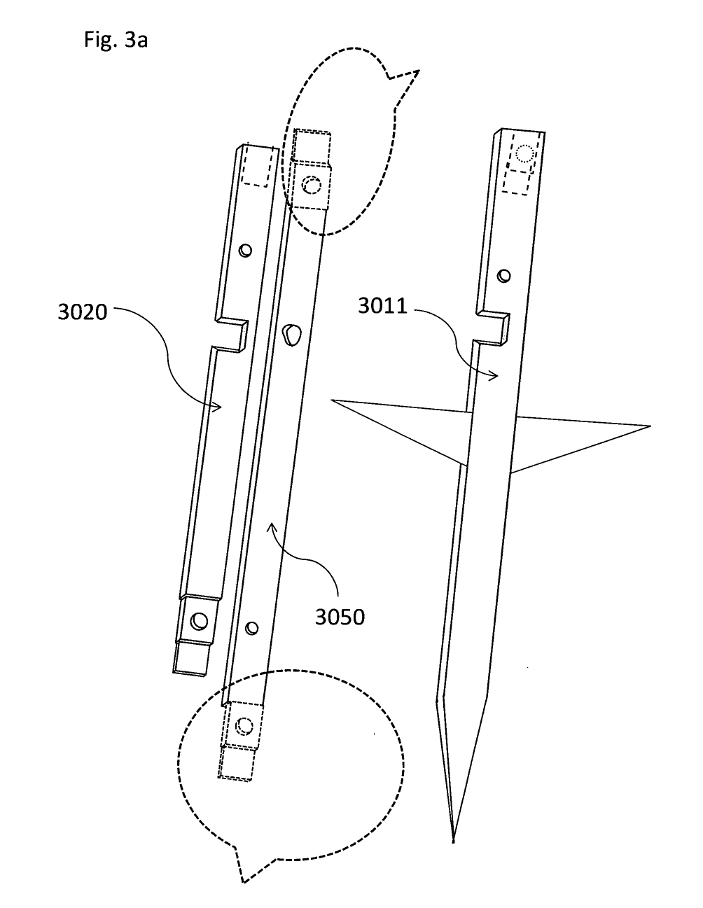

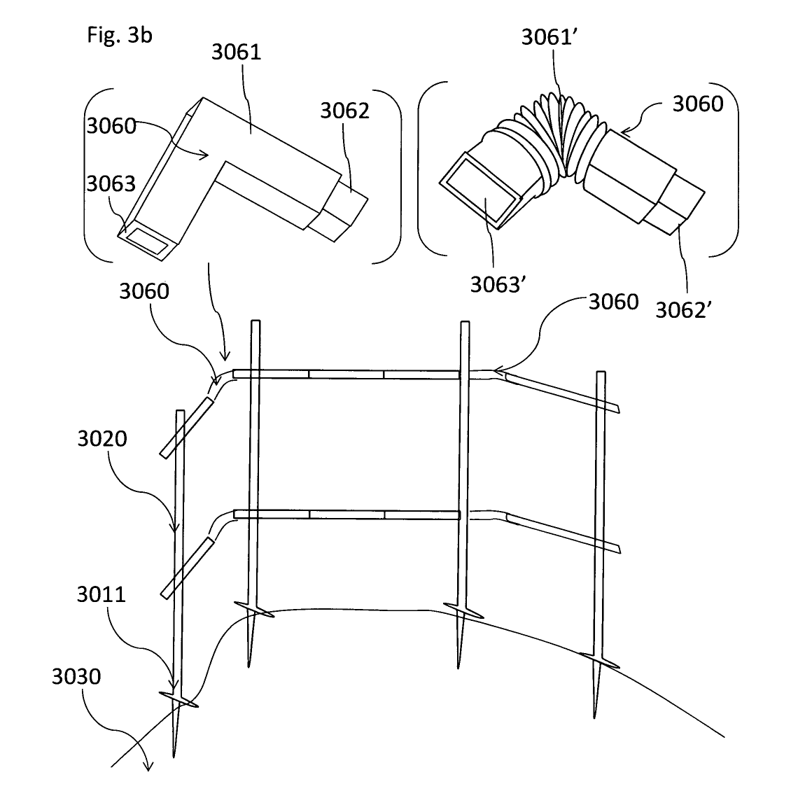

FIG. 3a is a schematic view of an embodiment of the adjustable stake assembly kit shown disassembled. As shown, the kit includes at least one universal stake support 3011, stake segment 3020, and in the embodiment shown at least one lateral connector section 3050. Lateral connector section is appointed to fit cross-wise in relation to the stake support and/or the stake segment.

FIG. 3b is a schematic view of the embodiment of the adjustable stake assembly kit shown generally assembled and with corner connectors. As shown, the kit further includes corner connectors 3060 that are generally constructed having a substantially 90 degree angle with mating portions on each end to mate with a universal stake support 3011, stake segment 3020 and or lateral connector section 3050. The corner connectors 3060 include an angled body 3061, mating connection tab 3062 and an end aperture 3063. The corner connectors 3060 may be constructed so that both ends have a tab 3062 or both ends have an aperture 3063 for versatility. The corner connectors 3060 may further include an accordion central body 3061′ that can be bent to and fro to form a desired angle. In this construct, the corner connectors can be used to create a closed pen or the like. The accordion style corner connector is open on both ends and has sufficient flexibility to adjust the angle to one other than 90°. The accordion style corner connector is preferably composed of a hard flexible rubber or other material that resists ultra violate light and has a stiffness that supports the joint with sufficient strength to retain the angle established for the horizontal components of the stake. Such a flexible joint creating component advantageously provides added flexibility when generating various trellis and/or fence or pen shapes.

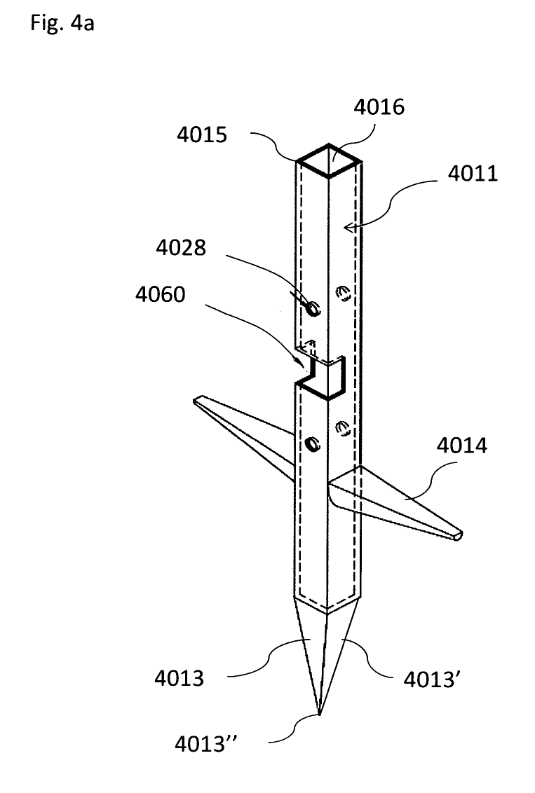

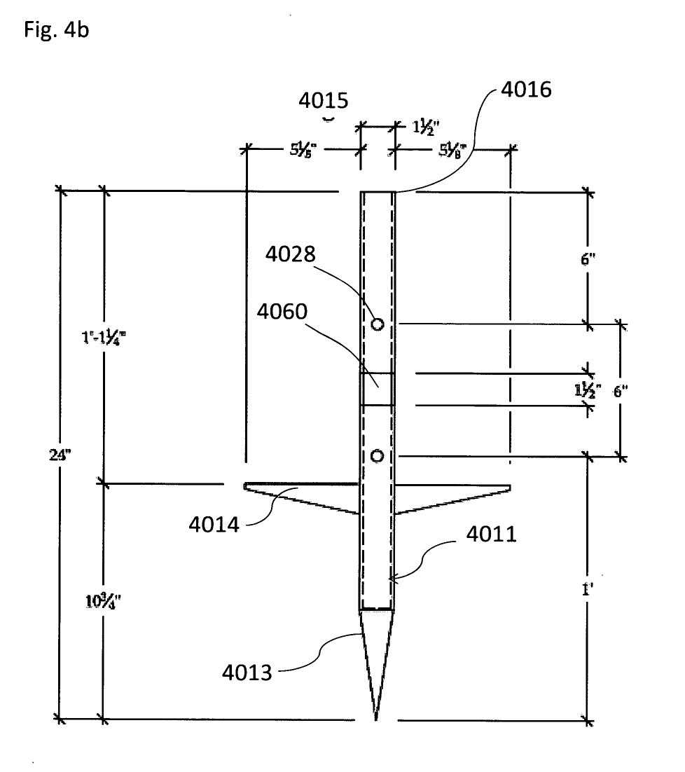

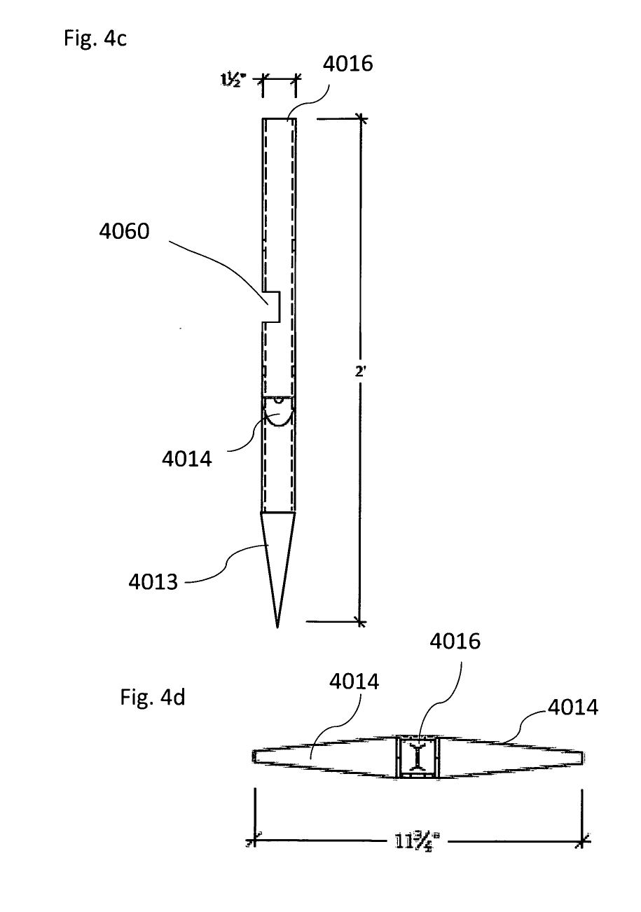

FIG. 4a is a schematic view of another embodiment of a stake support. FIG. 4b is a front view of the stake support. FIG. 4c is a side view of the stake support. FIG. 4d is a top view of the stake support. Referring to FIGS. 4a-4d, the universal stake support 4011 comprises a first and second end, the first end having an angular-sharp tip 4013 to penetrate a surface. The stake support 4011 has a body portion 4012 and a horizontal member 4014. The second end has a protrusion 4015 with a stake aperture 4016 integrated therein. Horizontal member 4014 is formed within the stake support 4011 and is located in the body portion 4012 near tip 4013. Horizontal member 4014 is substantially perpendicular to said body portion 4012 and tip 4013. Horizontal member 4014 is formed having triangular shape so that the underside of the horizontal member 4014 is angled so that the member 4014 can rest flush against the ground, while the top of the horizontal member 4014 is substantially flat so that a user's foot can rest on the top of the horizontal member 4014. Support holes/apertures 4028 are preferably provided for insertion of ties or the like and are preferably spaced about 6 inches apart from one another.

As shown in this embodiment, the body portion 4012 of the stake segment 4011 has a substantially concave lateral notch 4060 formed therein located above the horizontal member 4015. Preferably the concave lateral notch 4060 is formed as a substantially open bracket-shaped concave notch as shown and the flange of a stake segment is correspondingly substantially a square or rectangular shaped portion so that the flange fits and is secured within the open bracket-shaped concave notch 4060. Preferably at least one lateral connector section (not shown) is provided that has flanges on both ends appointed to fit within the lateral notch 4060 for cross-wise connection.

The angular-sharp tip 4013 of the stake support 4011 is formed as a wedge-shaped member with angled flat sides 4013′ converging to an angular pointed tip 4013″. In this manner, the stake support 4011 is found to enter the ground similar to that of a wedge and optimally deflects rocks and pebbles for ease in insertion. Preferably, stake aperture 4016 of the stake support 4011 is formed as a substantially square or rectangular shaped aperture and the flange of the stake segment is substantially a square or rectangular shaped portion so that the flange fits and is secured within the stake aperture.

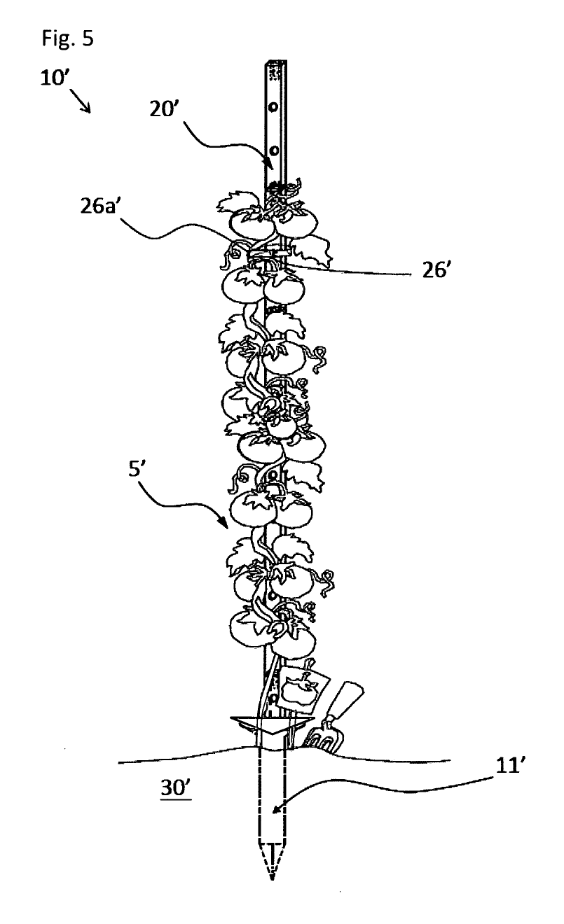

FIG. 5 shows a single adjustable stake assembly 10′ with the universal stake support 11′ inserted into the ground 30′ and stake segments 20′ stacked height wise as needed depending on the growth of a tomato plant 5′. Ties 26a′ may be utilized by simply wrapping around stake segments 20′ or by way of insertion through support holes/apertures 26′ to tie the tomato plant 5′ to the stake segment 20′.

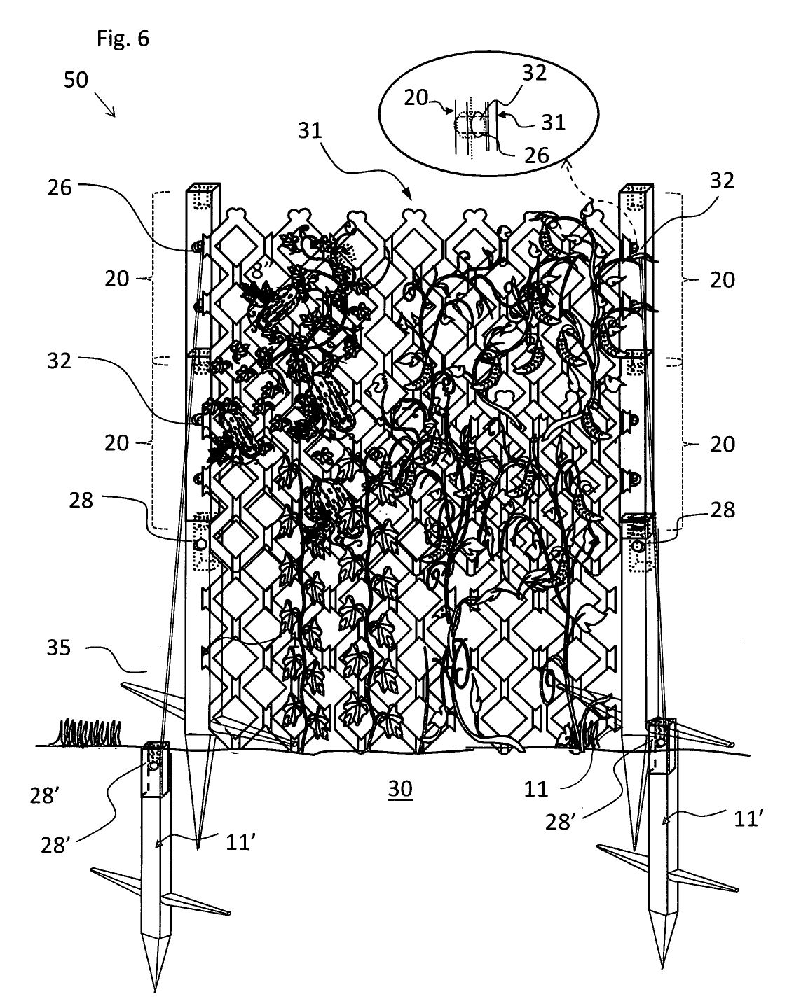

FIG. 6 is a schematic view of the first embodiment of the adjustable stake assembly erected with a lattice/fencing insert to form a lattice/fence, shown generally at 50. In the configuration shown, adjustable stake assembly is constructed having a universal stake support 11 with stake segments 20 snapped thereon. A lattice 31 is attached to each of the stake segments 20 and preferably the universal stake supports 11. Attachment may be facilitated in a number of ways. In one embodiment, the lattice 31 is attached via rope, string, cable zip tie, or the like simply wrapped around each of the stake segments 20 and preferably the universal stake supports 11 for securing. In another embodiment, attachment may be facilitated by attached via rope, string, cable zip tie, or the like simply by inserting same in the apertures 26, 28 of each of the stake segments 20 and universal stake supports 11 for securing. In yet another embodiment, the lattice 31 may include snap-knobs 32 that align with and snap into each of the apertures 26, 28 of each of the stake segments 20 and universal stake supports 11. Additional universal stake supports 11′ may be provided wherein a rope 35 extends from the assembly to the universal stake supports 11′ and attached thereto by way of support hole/aperture 28′ for adding support to the structure.

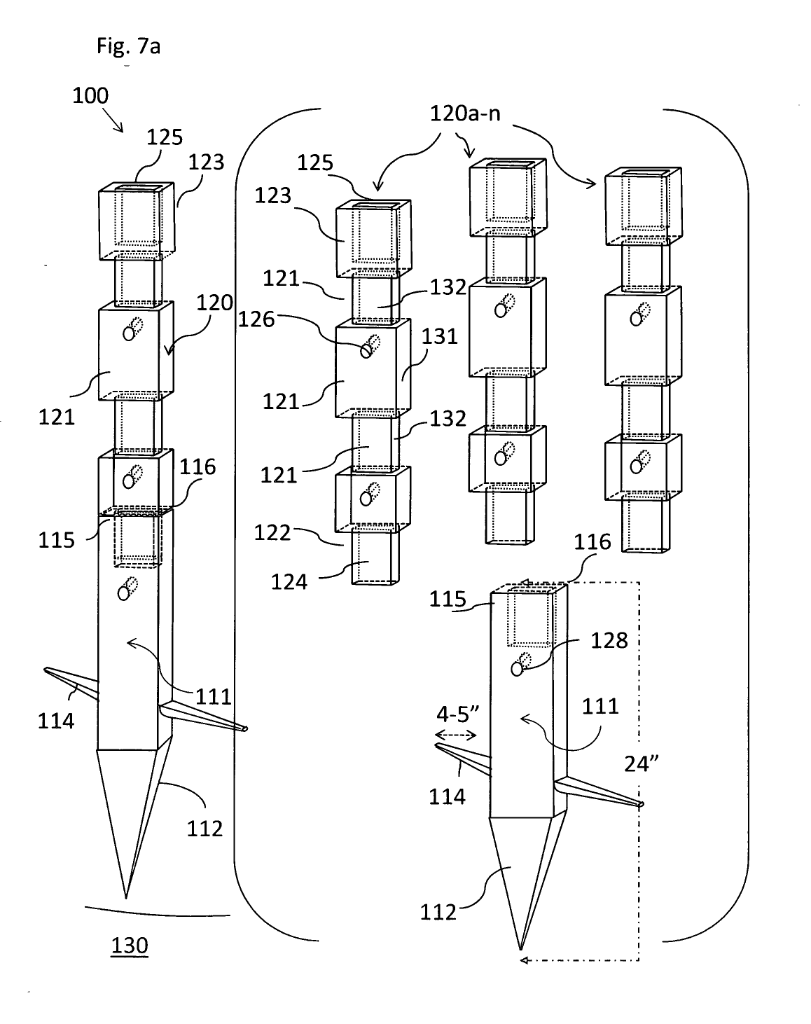

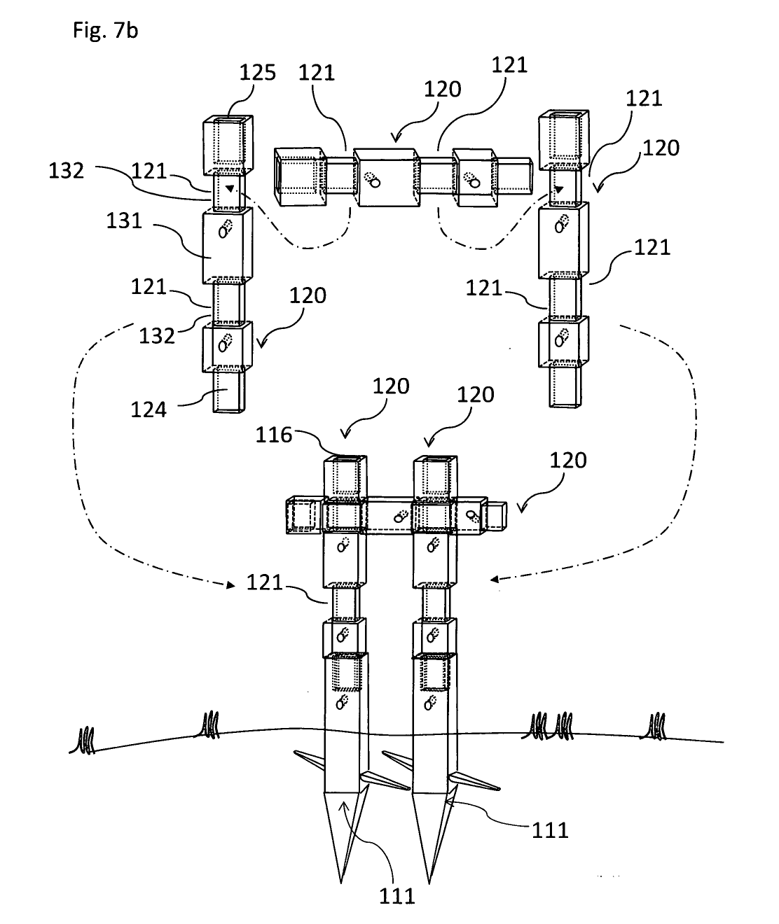

FIG. 7a is a schematic view of another embodiment of the adjustable stake assembly wherein the central portion of the stake segment comprises at least one lateral connector section, shown generally at 100. FIG. 7b shows the snap attachment of the segments. Herein shown, two lateral connector sections are provided, appointed for receiving lateral connector sections of other stake segments for cross-wise connection of the stake segments in relation to one another and in relation to universal stake supports. The adjustable stake assembly 100 includes a universal stake support 111 having a tip 112 appointed to penetrate a surface 130, a body portion 113 and a top plate 114 having a protrusion 115 with a stake aperture 116 integrated therein. At least one stake segment 120 having a central portion 121 and a lateral end 122 and distal end 123 is provided. The lateral end 122 includes a flange 124 appointed to be received in the stake aperture 116 of the universal stake support 111. The distal end 123 includes a segment aperture 125 integrated therein appointed for receiving another stake segment 120 for vertically stacking a plurality of the stake segments 120a-n. Stake segment 120 additionally includes a plurality of support holes/apertures 126 to tie tomatoes/plants/etc. to the stake segment 120. Universal stake support 111 may also include support hole/aperture 128 for insertion of ties or the like. In use the adjustable stake assembly can be pressed into the ground by stepping on the side projection/top plate 114.

In the embodiment shown, central portion 121 of the stake segment 120 comprises at least one lateral connector section 121 appointed for receiving at least one lateral connector section 121 of another stake segment 120 for cross-wise connection of the stake segments 120 in relation to one another. Preferably, at least two lateral connector sections 121 are provided as shown. Lateral connector sections 121 of central portion 121 are constructed having a major portion 131 abutting a minor portion 132. Minor portion 132 has a smaller size than the major portion 131 forming the lateral connector section 121 so that the sections 121 are formed as notches.

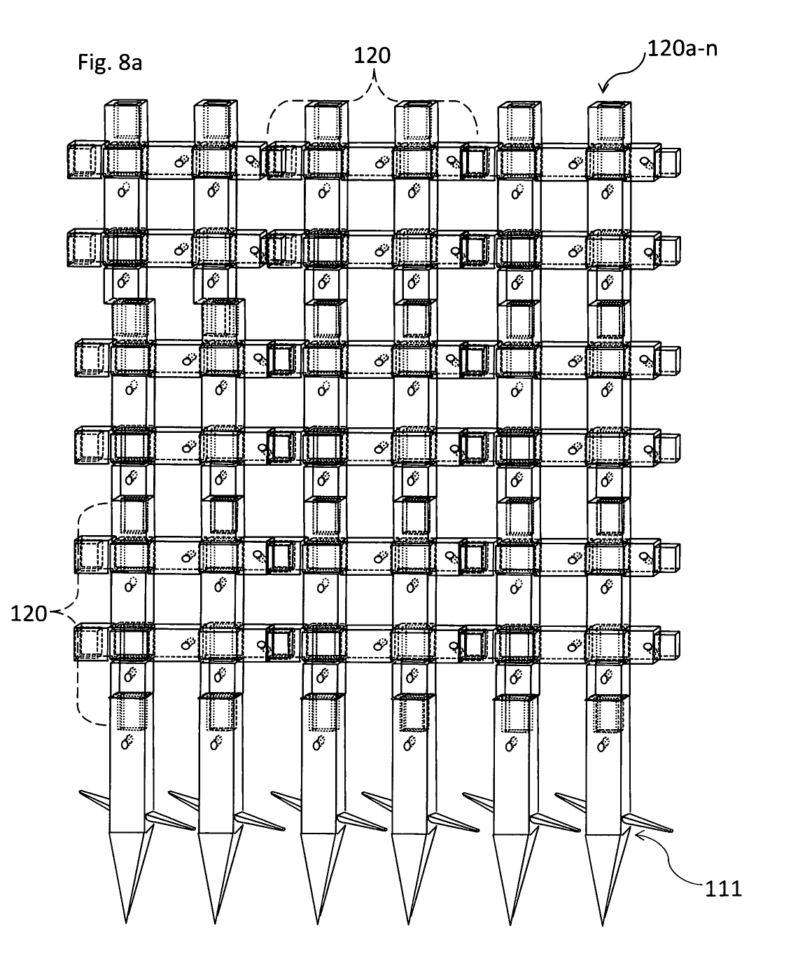

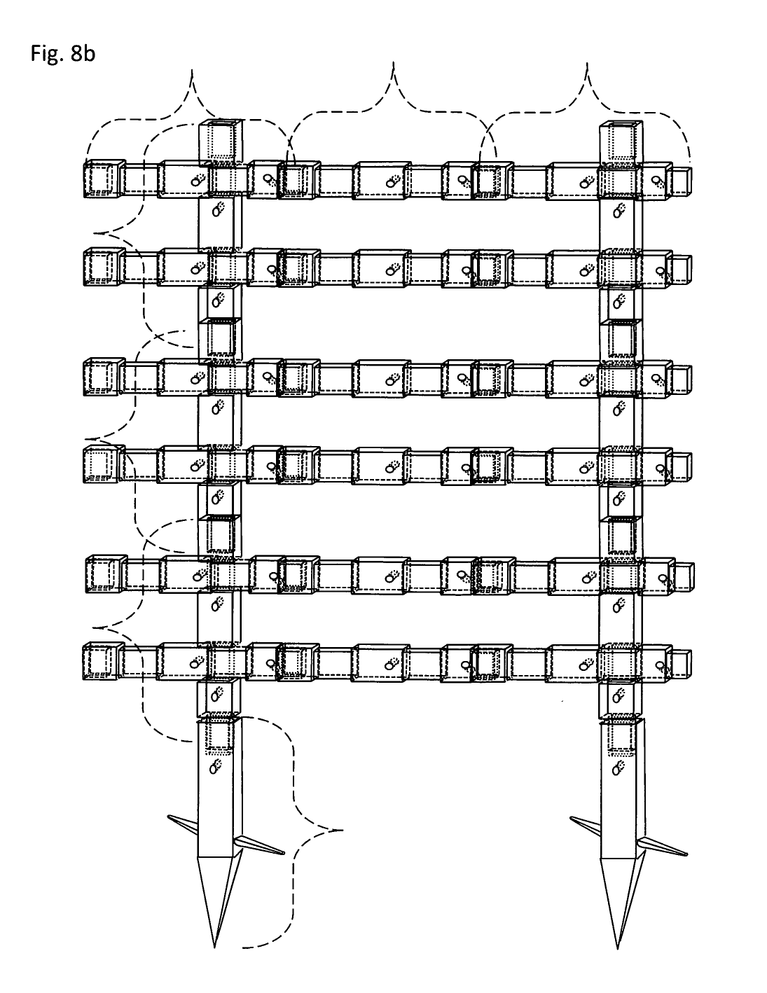

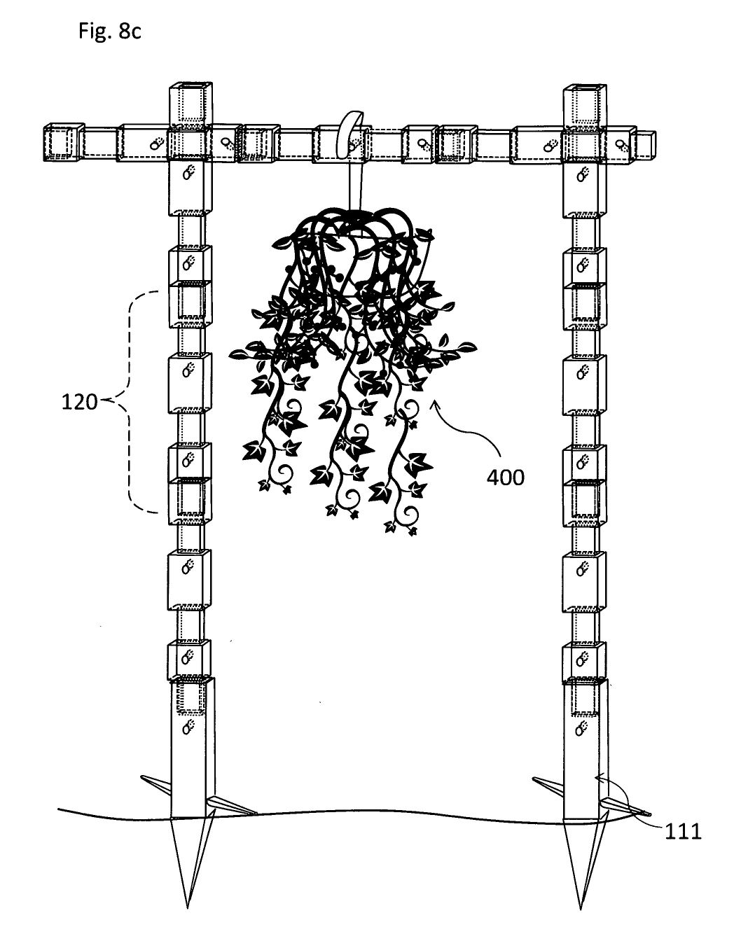

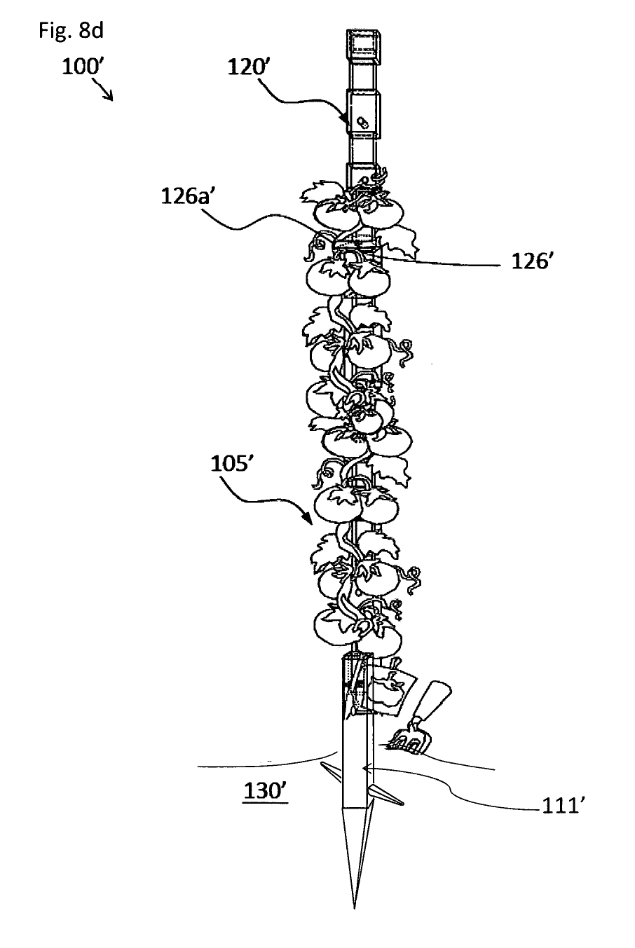

FIGS. 8a and 8d show different configurations of the embodiment of FIG. 7a snapped together to form a fence or lattice structure that may be used for a plethora of operations, including as a plant lattice, fencing around an area, to create a gate type structure, plant holder, or single support structure. Universal stake support 111 with stake segments 120 snapped thereon as discussed in relation to FIG. 7a, 7b is provided. Stake segments 120 are also horizontally cross-wise attached to one another at lateral connector sections 121 to form a fence or gate structure. FIG. 8c is a view of the embodiment of FIG. 7a snapped together to form a lattice structure in another configuration such as for holding hanging baskets 400. FIG. 8d is a view of the embodiment of FIG. 7a showing a single adjustable stake assembly 100′ with the universal stake support 111′ inserted into the ground 130′ and stake segments 120′ stacked height wise as needed depending on the growth of a tomato plant 105′. Ties 126a′ may be utilized by simply wrapping around stake segments 120′ or by way of insertion through support holes/apertures 126′ to tie the tomato plant 105′ to the stake segment 120′.

FIG. 9 is a view of the adjustable stake assembly being configured to hold a fence attachment for landscaping plants. Herein universal stake supports 511 are shown staked into the ground 530. Although the universal stake supports 511 do not include stake segments inserted therein, it is to be understood that stake segments can readily be inserted therein if needed for greater height. A landscape boarder or shallow fence 550 is mounted on universal stake supports 511. Mounting of the landscape boarder 550 can be achieved by simply applying pressure from the top plate 514 pressing downward on the boarder 550 so that the boarder is jammed between the ground 530 and the top plate 514. Alternatively, top plate 514 may include a u-shaped lip 514′ that retains boarder 550.

FIG. 10 is a view of the adjustable stake assembly being configured to hold a cross-link fence attachment for keeping pests out of a garden. Herein universal stake supports 611 are shown staked into the ground 630 with stake segments 620 inserted therein; it is to be understood that addition stake segments 620 can readily be inserted therein if needed for greater height. A mesh fence 650 is mounted on the universal stake supports 611 and stake segments 620. Mounting of the mesh fence 650 can be achieved by simply tying the fence 650 to the stake supports 611 and stake segments 620 via rope, string, or zip ties simply wrapped around each of the stake segments 620 or via entry into apertures 626, 628 of the segments 620 and/or universal stake support 611 for securing. In another embodiment, the mesh fence 650 may include snap-knobs 652 that align with and snap into each of the apertures 626, 628 of each of the stake segments 620 and universal stake supports 611.

FIG. 11 is a view of the adjustable stake assembly, universal stake support 711 with stake segments 720, arranged to receive a snap-on plate tray 750 add-on for forming a plant holder, or small table top. Snap-on plate tray 750 includes a flange 754 appointed to be received in the segment aperture 725 of the stake segment 720/or where no stake segments 720 are attached, within stake aperture 716 of universal stake support 711.

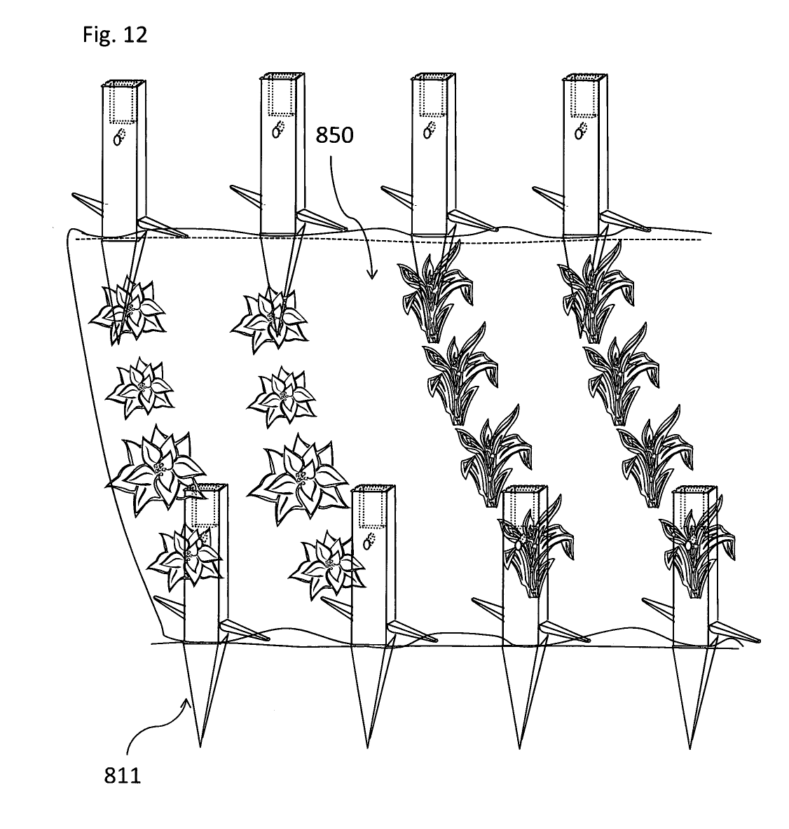

FIG. 12 is a view of the adjustable stake assembly wherein universal stake supports 811 are utilized to hold a tarp or plastic mulch 850. Although the universal stake supports 811 do not include stake segments inserted therein, it is to be understood that stake segments can readily be inserted therein if needed for greater height.

FIG. 13 is a view of the adjustable stake assembly being configured to hold a net attachment for forming a recreational net for volleyball or bad mitten, or the like. In the configuration shown, adjustable stake assembles are constructed having a universal stake support 911 with stake segments 920 snapped thereon forming two pole like structures 900′. Between the two pole-like structures 900′ a net 950 is inserted via attachment to stake segments 920. Attachment may be facilitated in a number of ways. In one embodiment, the net 950 is attached via rope, string, cable zip tie, or the like simply wrapped around each of the stake segments 920. In another embodiment, attachment may be facilitated by attached via rope, string, cable zip tie, or the like simply by inserting same in the apertures 926 of each of the stake segments 920. In yet another embodiment, the net 950 may include snap-knobs 932 that align with and snap into each of the apertures 926 of the stake segments 920. Additional universal stake supports 911′ may be provided wherein a rope 935 extends from the assembly to the universal stake supports 911′ and attached thereto by way of support hole/aperture 928′ for adding support to the structure.

FIG. 14 is a view of the adjustable stake assembly being configured to hold a flag attachment 1050 for forming a flag pole or decorative assembly. Flag attachment 1050 includes a flange 1054 appointed to be received in the stake aperture 1016 of the stake segment 1020. Preferably, the height of the flag pole—i.e. constructed via the universal stake support 1011 and vertically stacked stake segments 1020 is in a manner so that it is at least nine feet high.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. An adjustable stake assembly, comprising:
a. a universal stake support having a first and second end, said first end having an angular-sharp tip appointed to penetrate a surface, a body portion extending between said first and second ends, and a horizontal member, wherein said second end has a top wall that includes a stake aperture integrated therein;
b. said horizontal member being formed within said stake support located in said body portion and being substantially perpendicular to said body portion and said first and second ends and said angular-sharp tip;
c. at least one stake segment having a central portion and a lateral and distal end, said lateral end having a flange appointed to be received in said stake aperture of said universal stake support, and said distal end having a segment aperture integrated therein appointed for receiving another stake segment for vertically stacking a plurality of said stake segments;
d. said central portion of said stake segment comprising at least one support hole; and
e. said lateral end of said stake segment including at least one support hole.

2. An adjustable stake assembly as recited by claim 1, wherein said body portion of said stake segment has a substantially concave lateral notch formed therein above said horizontal member.

3. An adjustable stake assembly as recited by claim 1, wherein said concave lateral notch is formed as a substantially open bracket-shaped concave notch and said flange of said stake segment is substantially a square or rectangular shaped portion so that said flange fits and is secured within said open bracket-shaped concave notch.

4. An adjustable stake assembly as recited by claim 1 comprising at least one lateral connector section having flanges on both ends appointed to fit within said lateral notch for cross-wise connection of said lateral connector sections and stake segments in relation to one another.

5. An adjustable stake assembly as recited by claim 1, wherein said angular-sharp tip of said stake support is formed as a wedge-shaped member with angled flat sides converging to an angular pointed tip.

6. An adjustable stake assembly as recited by claim 1, wherein said stake aperture of said stake support is formed as a substantially square or rectangular shaped aperture and said flange of said stake segment is substantially a square or rectangular shaped portion so that said flange fits and is secured within said stake aperture.

7. An adjustable stake assembly as recited by claim 1, wherein said flange of said stake segment includes a locking mechanism for releasably securing said flange within said aperture of said stake support.

8. An adjustable stake assembly as recited by claim 1, wherein said universal stake support includes at least one support hole.

9. An adjustable stake assembly as recited by claim 1, wherein said stake segment includes at least one fastener means.

10. An adjustable stake assembly as recited by claim 1, wherein said universal stake support has 12 to 32 inches in height.

11. An adjustable stake assembly as recited by claim 1, wherein said universal stake support is 24 inches in height.

12. An adjustable stake assembly as recited by claim 1, wherein said horizontal member of said universal stake support has a triangular shape extending on both sides of said body portion of said stake support.

13. An adjustable stake assembly as recited by claim 1, wherein said horizontal member of said universal stake support has a length extending from each side of said body portion of said stake support ranging from about 3 to about 12 inches.

14. An adjustable stake assembly as recited by claim 1, wherein said horizontal member of said universal stake support has a length extending from each side of said body portion of said stake support of about 4 to about 6 inches.

15. An adjustable stake assembly as recited by claim 1, wherein said tip of said universal stake support has a length ranging from about 3 to about 12 inches.

16. An adjustable stake assembly as recited by claim 1, wherein said horizontal member and said tip of said universal stake support are substantially equal in length.

17. An adjustable stake assembly as recited by claim 1 comprising a lattice fencing structure.

18. An adjustable stake assembly as recited by claim 1 comprising a fencing portion.

19. An adjustable stake assembly as recited by claim 1 comprising add-on accessories including a snap-on plate tray.

20. An adjustable stake assembly as recited by claim 1 comprising a corner connector.

21. An adjustable stake assembly as recited by claim 21, wherein said corner connector includes an accordion or expandable body portion.

22. A method of using an adjustable stake assembly, comprising the steps of:
a. selecting a universal stake support, comprising:
i. a first and second end, said first end having an angular-sharp tip appointed to penetrate a surface, a body portion extending between said first and second ends, and a horizontal member, wherein said second end has a top wall that includes a stake aperture integrated therein;
ii. said body portion having a substantially concave lateral notch formed therein;
iii. said horizontal member being formed within said stake support located in said body portion and being substantially perpendicular to said body portion and said first and second ends and said angular-sharp tip;
b. inserting said universal stake support into said surface;
c. applying force to said horizontal member causing said pointed tip of said stake support to penetrate into said surface;
d. attaching at least one stake segment onto said universal stake support, said stake segment having:
i. a central portion and a lateral and distal end, said lateral end having a flange appointed to be received in said stake aperture of said universal stake support, and said distal end having a segment aperture integrated therein appointed for receiving another stake segment for vertically stacking a plurality of said stake segments;
ii. said central portion of said stake segment comprising at least one support hole;
iii. said lateral end of said stake segment including at least on support hole.
